(19) United States
(12) Patent Application Publication
(10) Pub. No.: US 2012/0207904 A1
(43) Pub. Date: Aug. 16, 2012

(54) Gluten Free Structured Protein Product

(76) Inventors: Wesley W. Twombly, St. Louis, MO (US); Kurt A. Busse, St. Louis, MO (US)

(21) Appl. No.: 13/502,394

(22) PCT Filed: Oct. 29, 2010
(86) PCT No.: PCT/US10/54719

§ 371 Date: Apr. 17, 2012

Related U.S. Application Data
(60) Provisional application No. 61/256,965, filed on Oct. 31, 2009.

(51) Int. Cl. A23J 1/00; A23L 1/305; A23L 1/317; A23P 1/12; A23L 1/27; A23L 3/3454

(52) U.S. Cl. 426/540; 426/656; 426/541; 426/641; 426/574

(57) ABSTRACT

The invention relates to a structured protein product comprised of a texturizable protein and a binding agent. The invention also relates to a method for extruding a wheat-free, and more particularly, gluten-free structured protein product with substantially aligned protein fibers. The method also works for wheat-containing blends.

### FIELD OF THE INVENTION

The present invention provides a structured protein product and method of making such product with the resultant product being a highly structured protein product. In particular, the structured protein product includes protein and optionally a binding agent, and is preferably wheat or gluten free.

### CROSS REFERENCE TO RELATED APPLICATION

This application claims priority to U.S. provisional patent application 61/256,965, filed Oct. 31, 2009, which is herein incorporated by reference in its entirety.

### BACKGROUND OF THE INVENTION

Food developers have devoted much time developing methods for preparing acceptable meat-like food products, such as beef, pork, poultry, fish, and shellfish analogs, from a wide variety of plant proteins. Soy protein has been utilized as a protein source because of its relative abundance and reasonably low cost. Extrusion processes can be used to prepare meat analogs. Upon extrusion, the extrudate generally expands to form a somewhat structured material. To date, meat analogs made from high protein extrudates have had limited acceptance because they lack muscle-like texture characteristics and mouthfeel. Rather, they are characterized as spongy and chewy, largely due to the random structures that are formed. A common application is as an extender for ground, hamburger-type meats.

Further, because of allergies and aversion by some consumers to wheat or gluten it is desired to produce a structured protein product without the use of ingredients that include wheat or wheat gluten.

There is still an unmet need for producing a wheat or gluten-free structured protein product that simulates the fibrous structure of animal meat and has an acceptable muscle-like texture using primarily unstructured ingredients.

### SUMMARY OF THE INVENTION

An important aspect of the present invention is the development of a structured protein product from primarily unstructured ingredients. This structured protein product can have a consistency similar to cooked animal meat. The present invention in particular is a structured protein product that can optionally include a binding agent. If the protein includes at least one oligosaccharide or polysaccharide component the protein can be used without additional constituents. Two or more proteins can be used without additional constituents. These constituents must allow the protein to stretch in the shear field during extrusion to create elongated protein strands having a structure similar to cooked animal meat. As such, the protein and the binding agent, when used, should allow the protein to stretch into strands during extrusion that can later be mechanically separated. Exemplary binding agents include oligosaccharides, polysaccharides, di-saccharides, mono-saccharides, other starches, lipids, and any protein other than the protein used as the main protein.

Current products similar to the present invention use wheat gluten in the formulation; however, the present invention does not require wheat and/or gluten. As such, the present invention may incorporate a variety of texturizable proteins to create a structured protein product that exhibits substantially aligned fibers. The invention also provides a process for producing a structured protein product. The finished product can be used to create a restructured vegetarian, whole muscle-like product, restructured meat product, or other food composition where the protein strands provide structure in the final product. In summary, the structured protein product will contain at least one protein and optionally a binding agent, along with other optional constituents. The protein content will be between about 40% and about 100% on a dry weight basis of the structured protein product. The optional binding agent can be added in an amount equal to between about 0% and about 35% on a dry weight basis of the structured protein product.

Another aspect of the invention provides a process for producing a restructured meat composition comprising the structured protein product of the current invention.

A further aspect of the invention provides a structured protein product for use in a variety of products.

### FIGURE LEGENDS

FIG. 1a depicts an image of a micrograph showing chicken muscle fibers. FIG. 1b depicts an image of a micrograph showing a structured protein product of the present invention using an isolated soy protein, tapioca starch, and other ingredients.

FIG. 2 depicts an image of a micrograph showing a structured protein product of the present invention using an isolated soy protein, corn flour, and other ingredient.

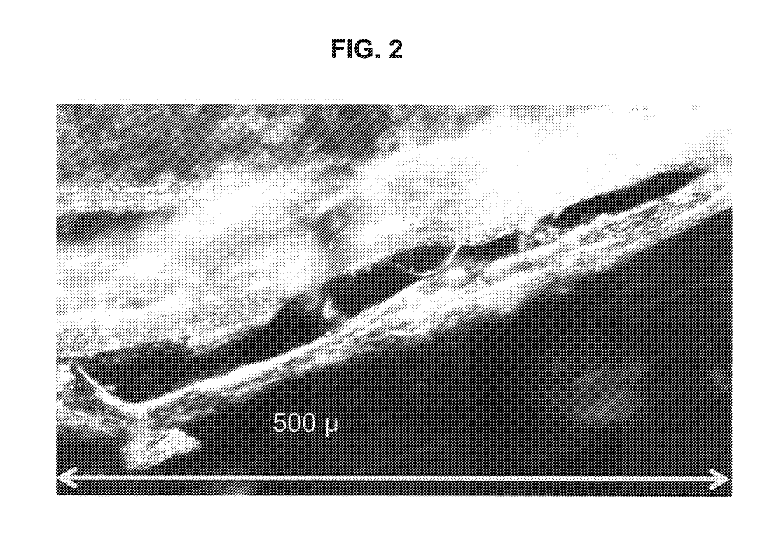

FIG. 3 depicts an image of a micrograph showing a structured protein product of the present invention using an isolated soy protein, rice flour, and other ingredient.

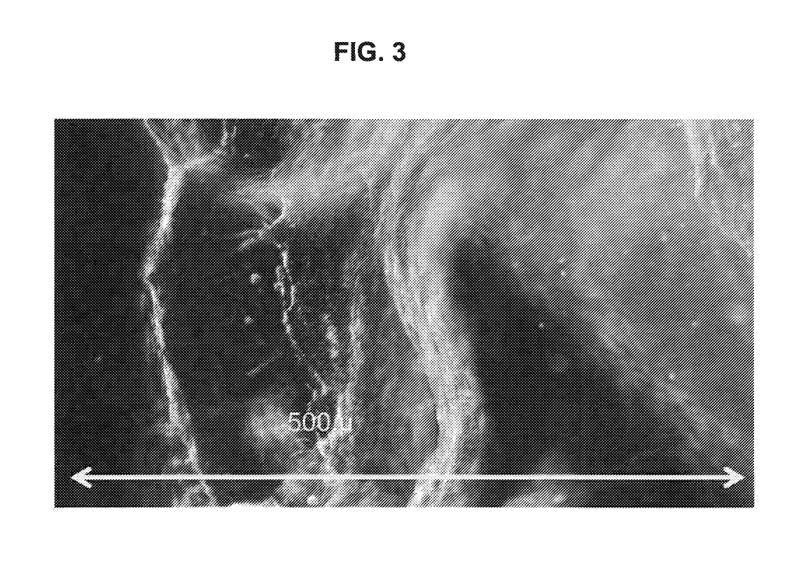

FIG. 4 depicts an image of a micrograph showing a structured protein product of the present invention using an isolated soy protein and tapioca starch only.

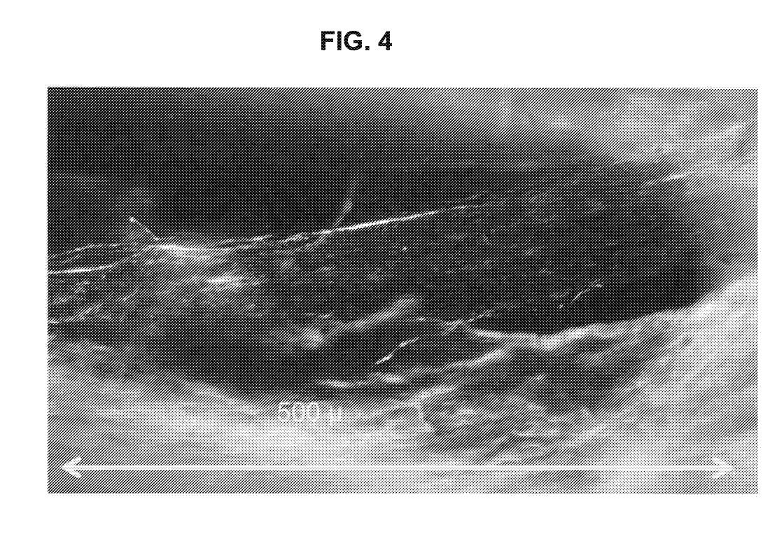

FIG. 5a depicts an image of a micrograph showing commercially available textured soy concentrate. FIG. 5b depicts an image of a micrograph showing a structured protein product of the present invention using a soy protein concentrate, tapioca starch, and other ingredients.

FIG. 6a depicts an image of a micrograph showing commercially available textured soy flour. FIG. 6b depicts an image of a micrograph showing a structured protein product of the present invention using a soy flour.

### REFERENCE TO COLOR FIGURES

The application contains at least one photograph executed in color. Copies of this patent application publication with color photographs will be provided by the Office upon request and payment of the necessary fee.

### DETAILED DESCRIPTION OF THE INVENTION

The present invention provides a process for creating a structured protein product from ingredients which do not possess the desired structure. In particular, the present invention relates to a structured protein product that can be wheat and/or gluten free. The resultant product comprises at least one protein and an optional binding agent.

Irrespective of its source or ingredient classification, the ingredients utilized in the extrusion process are typically capable of forming extrudates having protein fibers that are substantially aligned. Suitable examples of such ingredients are detailed more fully below.

The protein ingredient to be used in the structured protein product is a protein that can be texturized. Proteins that can be texturized include but are not limited to soy proteins. Since a wheat free or gluten free product is preferred the protein used should not be from wheat or a closely related species or sub-species.

Specific soy protein products include soy protein isolate products. The soy protein isolate should be used with the binding agent to form a fibrous protein product. Optional ingredients can be added to give the product the additional desired characteristics.

A second product, comprises a soy protein concentrate that can be used with a binding agent to form a structured protein product. Optional ingredients can be added to give the product additional desired characteristics.

A third product, comprises a soy flour that may be used with a binding agent to form a structured protein product. An additional binding agent is not required with this third product. Other optional ingredients can be added to give the product additional desired characteristics.

Thus, the protein sources include, but are not limited to: soy flour, soy protein concentrate, soy protein isolate, other texturizable proteins, and combinations thereof.

### (A) Protein-Containing Materials

(i) Plant Protein Materials

In an exemplary embodiment, at least one ingredient derived from a plant will be utilized to form the protein-containing materials. Generally speaking, the ingredient will comprise a protein. The amount of protein present in the ingredient(s) utilized can and will vary depending upon the application. For example, the amount of protein-containing ingredient(s) utilized in the composition may range from about 45% to about 100% by weight (dry basis) of the composition. In another embodiment, the amount of protein present in the protein-containing ingredient(s) utilized may range from about 50% to about 100% by weight (dry basis) of the composition. In a further embodiment, the amount of protein present in the protein-containing ingredient(s) utilized may range from about 60% to about 100% by weight (dry basis) of the composition. In still another embodiment, the amount of protein present in the protein-containing ingredient(s) utilized may range from about 70% to about 100% by weight (dry basis) of the composition. In an even further embodiment, the protein-containing ingredient(s) range from about 75% to about 100% by weight (dry basis) of the composition. In still another embodiment, the protein-containing ingredient(s) range from about 75% to about 90% by weight (dry basis) of the composition.

The protein-containing ingredient(s) utilized in extrusion may be derived from a variety of suitable plants. The plants may be grown conventionally or organically. By way of non-limiting example, suitable plants may include legumes, corn, peas, canola, sunflowers, sorghum, amaranth, potato, tapioca, arrowroot, canna, lupin, rape, oats, and mixtures thereof. Preferably, the protein is soybean derived.

(ii) Soy Protein Materials

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybean may be non-genetically modified soybeans, genetically modified soybeans, and combinations thereof.

In one embodiment, the soy protein material may be a soy protein isolate. In general, a soy protein isolate has a protein content of at least about 90% soy protein on a moisture-free (dry) basis. Generally speaking, when soy protein isolate is used, an isolate is preferably selected that is not a highly hydrolyzed soy protein isolate. However, in certain embodiments, highly hydrolyzed soy protein isolates may be used in combination with other soy protein isolates, provided that the highly hydrolyzed soy protein isolate content of the combined soy protein isolates is generally less than about 40% of the combined soy protein isolates, by weight. Examples of soy protein isolates that are useful in the present invention are commercially available, for example, from Solae, LLC (St. Louis, Mo.), and include SUPRO® 500E, SUPRO® EX33, SUPRO® 620, SUPRO® EX45, SUPRO® 595, and combinations thereof.

Alternatively, soy protein concentrate may be used alone or may be blended with the soy protein isolate as a source of soy protein material. Typically, if a soy protein concentrate is blended with soy protein isolate, the soy protein concentrate is used at levels from about 1% to about 99% of the combined weight of the protein ingredients. In one embodiment, the soy protein concentrate can be used at levels up to about 50% of the combined weight of the protein ingredients. It is also possible in an embodiment to use soy protein concentrate at about 40% of the combined weight of the protein ingredients. In another embodiment, the amount of soy protein concentrate used is up to about 30% of the combined weight of the protein ingredients. Examples of suitable soy protein concentrates useful in the invention include PROCON® 2000, ALPHA® 12, ALPHA® 5800, and combinations thereof, which are commercially available from Solae, LLC (St. Louis, Mo.).

Soy flour may be used alone or may be blended with soy protein isolate, soy protein concentrate, or both soy protein isolate and soy protein concentrate as a source of soy protein material. If soy flour is combined with the soy protein isolate, the soy flour is used at levels from about 1% to about 99% of the combined weight of the protein ingredients. When soy flour is used, the starting material is preferably a defatted soybean flour or flakes. Full fat soybeans contain approximately 40% protein by weight and approximately 20% oil by weight. These whole full fat soybeans may be defatted through conventional processes when a defatted soy flour or flakes form the starting protein ingredient. For example, the bean may be cleaned, dehulled, cracked, passed through a series of flaking rolls and then subjected to solvent extraction by use of hexane or other appropriate solvents to extract the oil and produce defatted flakes. The defatted flakes may be ground to produce a soy flour. Full fat soy flour may also serve as a protein source.

### Combinations of Protein-Containing Materials

Non-limiting combinations of protein-containing materials isolated from a variety of sources are detailed in Table A. In one embodiment, the protein-containing material is derived from soybeans. In another embodiment, the protein-containing material comprises a mixture of materials derived from soybeans and canola. In still another embodiment, the protein-containing material comprises a mixture of materials derived from soybeans, pea, and dairy, wherein the dairy protein is whey.

TABLE A
Combinations of Protein-Containing Materials.

| First protein ingredient | Second protein ingredient |
|---|---|
| soybean | Canola |
| soybean | Corn |
| soybean | Lupin |
| soybean | Oat |
| soybean | Pea |
| soybean | Rice |
| soybean | Sorghum |
| soybean | Amaranth |
| soybean | Arrowroot |
| soybean | Buckwheat |
| soybean | Cassava |
| soybean | channa (garbanzo) |
| soybean | Millet |
| soybean | Peanut |
| soybean | Potato |
| soybean | Sunflower |
| soybean | Tapioca |
| soybean | Dairy |
| soybean | Whey |
| soybean | Egg |
| soybean | canola and corn |
| soybean | canola and lupin |
| soybean | canola and oat |
| soybean | canola and pea |
| soybean | canola and rice |
| soybean | canola and sorghum |
| soybean | canola and amaranth |
| soybean | canola and arrowroot |
| soybean | canola and buckwheat |
| soybean | canola and cassava |
| soybean | canola and channa (garbanzo) |
| soybean | canola and millet |
| soybean | canola and peanut |
| soybean | canola and potato |
| soybean | canola and sunflower |
| soybean | canola and tapioca |
| soybean | canola and dairy |
| soybean | canola and whey |
| soybean | canola and egg |
| soybean | corn and lupin |
| soybean | corn and oat |
| soybean | corn and pea |
| soybean | corn and rice |
| soybean | corn and sorghum |
| soybean | corn and amaranth |
| soybean | corn and arrowroot |
| soybean | corn and buckwheat |
| soybean | corn and cassava |
| soybean | corn and channa (garbanzo) |
| soybean | corn and millet |
| soybean | corn and peanut |
| soybean | corn and potato |
| soybean | corn and sunflower |
| soybean | corn and tapioca |
| soybean | corn and dairy |
| Soybean | com and whey |
| Soybean | corn and egg |

### (B) Binding Agents

For the soy protein isolate or the soy protein concentrate based formulations, the binding agent, when used, will generally be added at an amount equal to between about 4% to about 25% by weight of the soy protein ingredients in the blend. For soy flour in the blend, a binding agent may be added in an amount equal to between about 0% to about 25% by weight of the soy flour in the blend. Because the binding constituent in the soy flour can serve the function of the binding agent in the other products, it is possible to combine soy flour and another soy protein source without the need to add a binding agent.

The binding agent need not be added as a separate ingredient, it can be a component of the protein ingredient. As an example, the oligosaccharides in soy flour serve as a binding agent, but occur as a portion of the soy flour rather than being a separately added ingredient. As such, the protein ingredients can comprise the entire composition.

When a binding agent is used in the product, it can be a starch source from various sources such as cereal, tuber, root, and other starch sources, or combinations thereof. Polysaccharides, oligosaccharides, mono- or di-saccharides can be used as the binding agent in the product. The binding agents can be used alone or in combinations. Without being bound by theory, the binding agent should allow the protein to elongate into separate strands by providing for a lower protein phase or region that may allow for spacing between protein strands.

As will be discussed, there are a variety of other ingredients that can be added to the compositions described above. These include, but are not limited to, colorants, flavorants, nutritional additives, cross-linking agents, humectants, dietary fiber, pH modifiers, etc. The other ingredients can range from between about 0% to about 45% by weight of the composition.

(i) Carbohydrates

It is envisioned that other ingredient additives in addition to proteins may be utilized in the structured protein products. Non-limiting examples of such ingredients include sugars, starches, oligosaccharides, and dietary fiber. As an example, starches may be derived from corn, tapioca, potato, rice, and the like. A suitable dietary fiber source may be any suitable dietary fiber (including, for example, soy cotyledon fiber. Dietary fiber may generally be present in the finished product in an amount ranging from about 1% to about 40% by weight on a moisture free basis, preferably from about 1% to about 20% by weight on a moisture free basis, and most preferably from about 1% to about 8% by weight on a moisture free basis. Suitable soy cotyledon fiber is commercially available. For example, FIBRARICH™, FIBRIM® 1270 and FIBRIM® 2000 are soy cotyledon fiber materials that are commercially available from Solae, LLC (St. Louis, Mo.).

(B) Additional Ingredients

(i) Antioxidants

A variety of additional ingredients may be added to any of the protein-containing materials detailed above without departing from the scope of the invention. For example, antioxidants, antimicrobial agents, and combinations thereof may be included. Antioxidant additives include BHA, BHT, TBHQ, rosemary extract, vitamins A, C and E and derivatives thereof. Additionally, various plant extracts such as those containing carotenoids, tocopherols or flavonoids having antioxidant properties, may be included to increase the shelf-life or nutritionally enhance the protein compositions. The antioxidants and the antimicrobial agents may have a combined presence at levels of from about 0.01% to about 10%, preferably, from about 0.05% to about 5%, and more preferably from about 0.1% to about 2%, by weight of the protein-containing materials.

(ii) Colorants

The structured protein product may comprise one or more colorants. The colorant is mixed with the protein-containing material and other ingredients prior to being fed into the extruder or the colorant is mixed with the protein-containing material and other ingredients while in the preconditioner or during the extrusion process, or other methods known to those skilled in the art for coloring an extrudate. Exemplary colorants that can be used are any colorant currently used in the food industry.

(iii) Flavorings

The structured protein product may comprise one or more flavorings. The flavoring agent may be mixed with the protein-containing material and other ingredients prior to being fed into the extruder or the flavoring agent may be mixed with the protein-containing material and other ingredients while in the preconditioner or during the extrusion process, or other methods known to those skilled in the art for flavoring an extrudate. Exemplary flavorings that can be used are any meat or meat-like flavors currently used in the food industry.

(iv) pH-adjusting Agent In some embodiments, it may be desirable to lower the pH of the extrudate to an acidic pH (i.e., below about 7.0). Thus, the protein-containing material may be contacted with a pH-lowering agent, and the mixture is then extruded according to the process detailed below. In one embodiment, the pH of the protein-containing material to be extruded may range from about 6.0 to about 7.0. In another embodiment, the pH may range from about 5.0 to about 6.0. In an alternate embodiment, the pH may range from about 4.0 to about 5.0. In yet another embodiment, the pH of the material may be less than about 4.0.

Several pH-lowering agents are suitable for use in the invention. The pH-lowering agent may be organic or inorganic. In exemplary embodiments, the pH-lowering agent is a food grade edible acid. Non-limiting acids suitable for use in the invention include acetic, lactic, hydrochloric, phosphoric, citric, tartaric, malic, and combinations thereof. In an exemplary embodiment, the pH-lowering agent is lactic acid.

As will be appreciated by a skilled artisan, the amount of pH-lowering agent contacted with the protein-containing material can and will vary depending upon several parameters, including, the agent selected and the desired pH.

In one embodiment, the amount of pH-lowering agent may range from about 0.1% to about 15% on a dry matter basis. In another embodiment, the amount of pH-lowering agent may range from about 0.5% to about 10% on a dry matter basis. In an alternate embodiment, the amount of pH-lowering agent may range from about 1% to about 5% on a dry matter basis. In still another embodiment, the amount of pH-lowering agent may range from about 2% to about 3% on a dry matter basis.

In some embodiments, it may be desirable to raise the pH of the protein-containing material. Thus, the protein-containing material may be contacted with a pH-raising agent, and the mixture is then extruded according to the process detailed below. Non-limiting pH-raising agents suitable for use in the invention include calcium hydroxide, sodium hydroxide, tricalcium phosphate, and combinations thereof. In an exemplary embodiment, the pH-raising agent is calcium hydroxide.

(v) Minerals and Amino Acids

The protein-containing material may also optionally comprise supplemental minerals. Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, selenium, and combinations thereof. Suitable forms of minerals include soluble mineral salts, slightly soluble mineral salts, insoluble mineral salts, chelated minerals, mineral complexes, non-reactive minerals such as carbonate minerals, reduced minerals, and combinations thereof.

Free amino acids may also be included in the protein-containing material. Suitable amino acids include the essential amino acids, i.e., arginine, cysteine, histidine, isoleucine, leucine, lysine, methionine, phenylalanine, threonine, tryptophan, tyrosine, valine, and combinations thereof. Suitable forms of the amino acids include salts and chelates.

(vi) Moisture Content

Typically, water is added to the extrusion process. The purpose of adding water is to hydrate the ingredients of the protein composition. Generally speaking, the moisture content of the material being extruded may range from about 17% to about 80% by wet-basis weight. In low moisture extrusion, the moisture content of the material being extruded may range from about 17% to about 40% by wet-basis weight. Alternatively, in high moisture extrusion applications, the moisture content of the material being extruded may range from about 35% to about 80% by wet-basis weight. In an exemplary embodiment, the extrudate will have a wet-basis moisture content ranging between about 25% and about 40% total extrudate moisture.

The blend of ingredients to be used includes at least one ingredient that has a high protein content (about 45% or more, by weight (dry basis) protein), and may include at least one binding agent that has a significant polysaccharide and/or oligosaccharide content. The high-protein ingredient can be selected from specific constituents such as soy isolates, concentrates, flours, other texturizable proteins, and combinations thereof. The optional binding agents include starches such as refined starches, starchy flours, other starchy ingredients, polysaccharides, and/or oligosaccharides. Other suitable binding agents can be used.

The combination of protein-containing ingredients may be combined with one or more ingredients selected from the group consisting of a starch, flour, dietary fiber, binding agent, and mixtures thereof.

(vii) Extrusion of the Protein-Containing Material

The preferred equipment for use in forming the protein product includes an extrusion system configured to run a conventional texturized protein product. This extrusion system may be equipped with a streamlined die allowing for the production of a fibrous product. The extruder may be used with a preconditioner.

The extruder should be an extruder with a screw configuration suitable to texturize protein. Most extruder manufacturers have suggested screw profiles and operating conditions that they will provide to their customers for the texturization of protein.

In order to texturize a protein, a wide combination of mechanical, thermal, and other energy can be used to reach suitable conditions. The primary need is to have the temperature of the extrudate reach between about 120° C. to about 160° C. Temperatures higher than 160° C. are possible. The energy to heat the extrudate to the needed temperatures can come from a variety of sources: mechanical energy input, steam injection, heat transfer, or any other method of heating the extrudate.

It needs to be noted that the extrudate temperature is the important measure, not the barrel wall measured temperatures or setpoints. The various barrel sections can be set to heat or cool as desired as long as a suitable extrudate temperature is reached. Perhaps the most accurate temperature measure is to have a thermocouple submerged in the flow of the melt, minimizing the influence of the barrel wall or die wall temperature on the temperature measurement. A less accurate, but more easily measured temperature is to turn off heating and cooling to at least the final barrel section, and preferably all sections, then allow the extruder to reach steady-state temperatures. The equilibrium temperature in the uncooled final barrel section is generally a reasonable approximation of the extrudate temperature.

A suitable extrusion process for the preparation of the structured protein products comprises introducing the protein-containing material, and other ingredients into a mixing vessel (i.e., an ingredient blender) to combine the ingredients and form a dry blended protein-containing material pre-mix. The dry blended protein-containing material pre-mix may be transferred to a hopper from which the dry blended ingredients are fed into a preconditioner. Water and/or steam may also be introduced at the preconditioner. The conditioned material is then fed to an extruder in which the mixture is heated under mechanical pressure generated by the screws of the extruder to form a molten extrusion mass. Alternatively, the dry blended protein material pre-mix may be directly fed to an extruder in which moisture and heat are introduced to form a molten extrusion mass. The molten extrusion mass exits the extruder through an extrusion die assembly forming a material comprising structured protein products having protein fibers that are substantially aligned. Other methods known to those skilled in the art, such as multiple feeders feeding individual ingredients, can be used.

(b) Optional Preconditioning

A preconditioner can be used. The function of a preconditioner is to have a step in the process where steam, water, and other ingredients can be added to the ingredient blend. The residence time in the preconditioner gives time for fluid ingredients and/or heat to penetrate into the particles of the mix. Water can be added at rates up to about 40% of the feed rate of the “dry” (“as-is”) formula.

In a preconditioner, the protein-containing material and optional additional ingredients (protein-containing mixture) may be preheated, contacted with moisture, and held under temperature and pressure conditions to allow the moisture to penetrate and soften the individual particles. The design configuration and rotational speed of the preconditioner may vary widely.

The protein-containing mixture may be preconditioned prior to introduction into the extrusion apparatus by contacting the ingredients with water and/or steam. The protein-containing mixture may be heated to a temperature of from about 30° C. to about 100° C., preferably from about 60° C. to about 95° C. in the preconditioner.

Typically, the ingredients are conditioned for a period of between about 0.5 minutes to about 10 minutes, depending on the speed and the size of the preconditioner. In one embodiment, the ingredients are conditioned for a period of between about 3 minutes to about 5 minutes. The ingredients are contacted with steam and/or water in the preconditioner. The water and/or steam conditions (i.e., hydrates) the ingredients prior to introduction to the extruder barrel.

(a) Extrusion Equipment

The extrusion apparatus generally comprises one or more screws, a barrel assembly, and die assembly.

Among the suitable extrusion apparatuses useful in the practice of the present invention is a twin-screw extruder as described, for example, in U.S. Pat. No. 4,600,311, which is hereby incorporated by reference in its entirety. Further examples of suitable commercially available extrusion apparatuses include a CLEXTRAL Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety. Single-screw or multiple-screw extruders may also be used.

The screws of a twin-screw extruder can rotate within the barrel in the same or opposite directions. Rotation of the screws in the same direction is referred to as co-rotating whereas rotation of the screws in opposite directions is referred to as counter-rotating. The speed of the screw or screws of the extruder may vary depending on the particular apparatus; however, it is typically from about 200 to about 800 revolutions per minute (rpm). The extrusion apparatus contains one or more screws assembled from shafts and screw elements, as well as mixing lobe and ring-type shearlock elements, or other elements as recommended by the extrusion apparatus manufacturer for extruding protein material or as developed by those skilled in the art.

Water may be injected into the extruder barrel to promote texturization of the proteins. As an aid in forming the molten extrusion mass, the water may act as a plasticizing agent. Water may be introduced to the extruder barrel via one or more injection points in communication with the extruder barrel. Typically, the mixture in the barrel contains from about 17% to about 80% wet-basis water by weight. In one embodiment, the mixture in the barrel contains from about 17% to about 40% by weight water.

(c) Extrusion Process

The dry ingredients or the conditioned ingredients are then fed into an extruder to heat, shear, and ultimately plasticize the mixture. The extruder may be selected from any commercially available extruder and may be a single screw extruder or preferably a twin-screw extruder that is capable of texturizing proteins.

The rate at which the ingredients are generally introduced to the extrusion apparatus will vary depending upon the particular apparatus. For example, a benchtop extruder may be fed at about 10 kg/hr, while large production equipment may be fed in the range of thousands of kilograms per hour.

The ingredients are generally subjected to shear and pressure by the extruder to plasticize the mixture. The screw elements of the extruder shear the mixture as well as convey the mixture forward through the extruder and through the die assembly.

The extruder may heat the ingredients as they pass through the extruder. The extruder generally includes the ability to heat or cool the barrel sections. If barrel cooling or heating is used, cooling is done by circulating a cooling medium; heating can be done by circulating a heating medium or by electrical heating. The extruder may also include steam injection ports for directly injecting steam into the barrel of the extruder. In one embodiment, the extruder barrel may be set in a multi-zone temperature control arrangement, where the zones are generally set with increasing temperatures from extruder inlet to extruder exit. The extruder may be set in other temperature zone arrangements, as desired.

The ingredient or ingredient blend is extruded, with the extrudate reaching a temperature of at least about 120° C. The extrudate is typically passed through a streamlined die resulting in a protein product that is highly structured.

The ingredients form a plasticized mass in the extruder. A die assembly is attached to the extruder in an arrangement that permits the plasticized mixture to flow from the extruder barrel exit into the die assembly, which preferably produces protein fibers that are substantially aligned as it flows through the die assembly. The die assembly may be a faceplate die, a peripheral die, or other dies capable of producing substantially aligned fibers.

As the need is for a streamlined die that allows the formation of substantially aligned fiber, many die designs are possible.

The critical design criteria in the die is to minimize build-up in the die or the opportunity for build-up to occur in the die and preferably to keep the stress that builds up in the extrudate below the strength of the extrudate. This build-up will cause problems for extended runs on the extruder, resulting in “burned” product going through the die, having a negative impact on quality. “Burned” product is product that reaches a dark or darker color due to reactions that occur at the elevated temperatures in the extruder and die. Keeping the stress that builds up in the plasticized extrudate below the strength of the plasticized extrudate allows the extrudate to exit the die with minimal distortions.

The extrudate is generally cut to a desired length after exiting the die assembly. The product may be dried after extrusion.

(I) Structured Protein Products

More specifically, the invention comprises structured protein products with protein fibers that are substantially aligned, as described in more detail below. In an exemplary embodiment, the structured protein products are produced using an extrusion process. Because the structured protein products have protein fibers that are substantially aligned in a manner similar to animal muscle, the protein compositions of the invention generally have the texture and eating quality characteristics of compositions comprised of up to one hundred percent (100%) animal muscle.

The desired moisture content may vary widely depending on the intended application of the product. Generally speaking, the product has a moisture content of from about 6% to about 13% by weight, if dried. The product need not be dried for all possible applications.

The product may further be comminuted to reduce the average particle size of the extrudate.

(D) Characterization of the Structured Protein Products

The structured protein product made by the method herein is typically comprised of protein fibers that are substantially aligned. In the context of this invention “substantially aligned” generally refers to the arrangement of protein fibers such that a significantly higher percentage of the protein fibers forming the structured protein product are contiguous to each other at less than approximately a 45° angle. The determination regarding whether the protein fibers are substantially aligned can be made by using a visual determination based upon micrographic images. Typically, an average of at least about 55% of the protein fibers comprising the structured protein product are substantially aligned. In another embodiment, an average of at least about 60% of the protein fibers comprising the structured protein product are substantially aligned. In a further embodiment, an average of at least about 70% of the protein fibers comprising the structured protein product are substantially aligned. In an additional embodiment, an average of at least about 80% of the protein fibers comprising the structured protein product are substantially aligned. In yet another embodiment, an average of at least about 90% of the protein fibers comprising the structured protein product are substantially aligned. Methods for determining the degree of protein fiber alignment are known in the art and may include visual determinations based upon micrographic images.

In addition to having protein fibers that are substantially aligned, the structured protein products also typically have shear strength substantially similar to whole meat muscle. In this context of the invention, the term “shear strength” provides a means to quantify the strength of the fibrous structure. Shear strength is the maximum force in grams needed to shear through a given sample. A method for measuring shear strength is described in Example 12.

Generally speaking, the structured protein products of the invention will have average shear strength of at least about 1400 grams. In an additional embodiment, the structured protein products will have average shear strength of from about 1500 to about 1800 grams. In yet another embodiment, the structured protein products will have average shear strength of from about 1800 to about 2000 grams. In a further embodiment, the structured protein products will have average shear strength of from about 2000 to about 2600 grams. In an additional embodiment, the structured protein products will have average shear strength of at least about 2200 grams. In a further embodiment, the structured protein products will have average shear strength of at least about 2300 grams. In yet another embodiment, the structured protein products will have average shear strength of at least about 2400 grams. In still another embodiment, the structured protein products will have average shear strength of at least about 2500 grams. In a further embodiment, the structured protein products will have average shear strength of at least about 2600 grams.

A means to quantify the size of the protein fibers formed in the structured protein products may be done by a shred characterization test. The shred characterization test can be found in Example 13. Shred characterization is a test that generally determines the percentage of long fibers formed in the structured protein product. In an indirect manner, percentage of shred characterization provides an additional means to quantify the degree of protein fiber alignment in a structured protein product. Generally speaking, as the percentage of long fibers increases, the degree of protein fibers that are aligned within a structured protein product also typically increases. Conversely, as the percentage of long fibers decreases, the degree of protein fibers that are aligned within a structured protein product also typically decreases.

The structured protein products of the invention typically have an average shred characterization of at least about 10% by weight of long fibers. In a further embodiment, the structured protein products have an average shred characterization of from about 10% to about 15% by weight of long fibers. In another embodiment, the structured protein products have an average shred characterization of from about 15% to about 20% by weight of long fibers. In yet another embodiment, the structured protein products have an average shred characterization of from about 20% to about 25% by weight of long fibers. In other embodiments, the average shred characterization is at least about 20% by weight of long fibers, at least about 30% by weight of long fibers, at least about 40% by weight of long fibers, at least about 50% by weight of long fibers, at least about 60% by weight of long fibers, at least about 70% by weight of long fibers, at least about 80% by weight of long fibers.

The structured protein products of the invention typically have an average shred characterization of at least about 10% by weight of long and short fibers. In a further embodiment, the structured protein products have an average shred characterization of from about 10% to about 15% by weight of long and short fibers. In another embodiment, the structured protein products have an average shred characterization of from about 15% to about 20% by weight of long and short fibers. In yet another embodiment, the structured protein products have an average shred characterization of from about 20% to about 25% by weight of long and short fibers. In other embodiments, the average shred characterization is at least about 20% by weight of long and short fibers, at least about 30% by weight of long and short fibers, at least about 40% by weight of long and short fibers, at least about 50% by weight of long and short fibers, at least about 60% by weight of long and short fibers, at least about 70% by weight of long and short fibers, at least about 80% by weight of long and short fibers, at least about 90% by weight of long and short fibers.

Suitable structured protein products of the invention generally have protein fibers that are substantially aligned, have average shear strength of at least about 1400 grams, and have an average shred characterization of at least about 10% by weight of long fibers. More typically, the structured protein products will have protein fibers that are at least about 55% aligned, have average shear strength of at least about 1800 grams, and have an average shred characterization of at least about 15% by weight of long fibers. In another embodiment, the structured protein products will have protein fibers that are at least about 55% aligned, have average shear strength of at least about 2200 grams, and have an average shred characterization of at least about 20% by weight of long fibers. In an exemplary embodiment, the structured protein products will have protein fibers that are at least about 55% aligned, have average shear strength of at least about 2600 grams, and have an average shred characterization of at least about 30% by weight of long fibers. In another exemplary embodiment, the structured protein products have an average shear strength of not more than about 7500 grams.

Measurement of product properties are likely to vary depending on the dimensions and geometry of the piece being measured. Unless stated otherwise, all measurements in this document relate to a cylindrical piece that has been dried to about 10% moisture and has dimensions of about 25 mm in diameter and is about 60 mm in length.

(E) Uses of the Product

The structured protein product disclosed herein can be used in any application that uses a texturized protein product. The present invention provides hydrated and shredded protein compositions and processes for producing each of the compositions. Typically, the protein composition will comprise structured protein products having protein fibers that are substantially aligned and may include a binding agent.

The compositions may be processed into a variety of food products having a variety of shapes. The application may be refrigerated, frozen, cooked, or partially cooked. It is also envisioned that applications could be made that would not require refrigeration, freezing, or cooking before consumption. Cooking may include frying, sautéing, deep-frying, baking, smoking, impingement cooking, steaming and other heating processes.

The application may be packaged as is without a cooking step. The application may be further processed by being shock-frozen, for example in a freeze tunnel, with subsequent packaging in containers of a suitable type, for example, plastic pouches or the like. Said type of further processing and packaging is suitable if the product is intended for fast-food outlets or for food service applications, where the product is usually cooked before consumption.

Alternatively, after the formation of the application, it is also possible to spray the surface of the application with carbohydrate solutions or related substances that permit uniform browning during frying, baking, or other thermal processes where browning is desired. Subsequently, the application may be shock-frozen and packaged. The application may be baked or processed in an oven. Further, the application may be breaded or otherwise coated prior to or after cooking.

Additionally, the application may be retort cooked. The cooked or uncooked application may also be packed and sealed in retortable containers. The application may be stuffed in impermeable casings designed for retort cooking and cooked to make a shelf stable application.

(i) Addition of Optional Ingredients

The restructured compositions may optionally include a variety of flavorings, spices, antioxidants, or other ingredients to impart a desired flavor or texture or to nutritionally enhance the final food product. As will be appreciated by a skilled artisan, the selection of ingredients added to the restructured compositions can and will depend upon the food product to be manufactured.

The restructured compositions may further comprise an antioxidant. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof.

The concentration of an antioxidant in the composition may range from about 0.0001% to about 20% by weight. In another embodiment, the concentration of an antioxidant in the composition may range from about 0.001% to about 5% by weight. In yet another embodiment, the concentration of an antioxidant in the composition may range from about 0.01% to about 1% by weight.

In an additional embodiment, the compositions may further comprise at least one flavoring agent. The flavoring agent may be natural, or the flavoring agent may be artificial.

The composition may optionally include a variety of flavorings. Suitable flavoring agents include animal meat flavor, animal fat, spice extracts, spice oils, natural smoke solutions, natural smoke extracts, yeast extracts, sherry, mint, brown sugar, honey. The flavors and spices may also be available in the form of oleoresins and aquaresins. Other flavoring agents include onion flavor, garlic flavor, or herb flavor. In an alternative embodiment, the flavoring agent may be nutty, sweet, or fruity. Non-limiting examples of suitable fruit flavors include apple, apricot, avocado, banana, blackberry, black cherry, blueberry, boysenberry, cantaloupe, cherry, coconut, cranberry, fig, grape, grapefruit, green apple, honeydew, kiwi, lemon, lime, mango, mixed berry, orange, peach, persimmon, pineapple, raspberry, strawberry, and watermelon. Herbs that may be added include bay leaves, basil, celery leaves, chervil, chives, cilantro, coriander, cumin, dill, ginger, mace, marjoram, pepper, turmeric, parsley, oregano, tarragon, and thyme. The compositions may further include flavor enhancers. Non-limiting examples of suitable flavor enhancers include sodium chloride salt, glutamic acid salts, glycine salts, guanylic acid salts, inosinic acid salts, and 5-ribonucleotide salts, yeast extract, shiitake mushroom extract, dried bonito extract, and kelp extract. The compositions may also utilize various sauces and marinades which may be made by fermentation or blending flavors, spices, oils, water, flavor enhancers, antioxidants, acidulents, preservatives, and sweeteners.

In an additional embodiment, the compositions may further comprise a thickening or a gelling agent, such as konjac flour, alginic acid and its salts, agar, carrageenan and its salts, processed Eucheuma seaweed, gums (Gum Arabic, carob bean, locust bean, guar, tragacanth, and xanthan), pectins, sodium carboxymethylcellulose, tera gum, methylcellulose, gelatin, and modified starches.

In a further embodiment, the compositions may further comprise a nutrient such as a vitamin, a mineral, an antioxidant, or an omega-3 fatty acid. Suitable vitamins include Vitamins A, C, and E, which are also antioxidants, and Vitamins B and D. Examples of minerals that may be added include the salts of aluminum, ammonium, calcium, magnesium, iron, and potassium. Suitable omega-3 fatty acids include docosahexaenoic acid (DHA), EPA (eicosapentanoic acid), SDA (stearadonic acid) and ALA (alpha-linolenic acid).

In another embodiment, the finished product can be used to create a restructured vegetarian, whole muscle-like product (i.e., meat-free or substantially meat-free), restructured meat product (i.e., meat containing), or other food composition where the protein strands provide structure in the final product.

When a restructured vegetarian, whole muscle-like product is the finished product, the structured protein products are blended with a comminuted vegetable or a comminuted fruit to produce a restructured vegetarian, whole muscle-like product.

When a restructured meat product is the finished product, the structured protein products are combined with an animal meat to produce a restructured meat product. A variety of animal meats are suitable for use in the restructured meat product. For example, the meat may be from a farm animal selected from the group consisting of sheep, cattle, goats, pork, bison, and horses. The animal meat may be from poultry, such as chicken, duck, goose or turkey. Alternatively, the animal meat may be from a game animal. Non-limiting examples of suitable game animals include buffalo, deer, elk, moose, reindeer, caribou, antelope, rabbit, squirrel, beaver, muskrat, opossum, raccoon, armadillo, porcupine, alligator, and snake. In a further embodiment, the animal meat may be from a fish or shellfish. Non-limiting examples of suitable fish or fish products include saltwater and freshwater fish, such as, catfish, tuna, salmon, bass, mackerel, pollack, hake, tilapia, cod, grouper, whitefish, bowfin, gar, paddlefish, sturgeon, bream, carp, trout, surimi, walleye, snakehead, and shark. In an exemplary embodiment, the animal meat is from beef, pork, or turkey. It is also envisioned that a variety of meat qualities may be utilized. For example, whole meat muscle that is either ground or in chunk or steak form may be utilized. The meat may have a fat content that varies widely.

Animal meat includes striated muscle which is skeletal or that which is found, for example, in the tongue, diaphragm, heart, or esophagus, with or without accompanying overlying fat and portions of the skin, sinew, nerve and blood vessels which normally accompany the meat flesh. Examples of meat by-products are organs and tissues such as lungs, spleens, kidneys, brain, liver, blood, bone, partially defatted low-temperature fatty tissues, stomachs, intestines free of their contents, and the like.

Typically, the amount of structured protein products in relation to the amount of animal meat in the restructured meat product can and will vary depending upon the intended use. By way of example, when a significantly vegetarian composition that has a relatively small degree of animal flavor is desired, the concentration of animal meat in the restructured meat composition may be about 45%, 40%, 35%, 30%, 25%, 20%, 15%, 10%, 5%, 2%, or 0% by weight. Alternatively, when a restructured meat product having a relatively high degree of animal meat flavor is desired, the concentration of animal meat in the restructured meat product may be about 50%, 55%, 60%, 65%, 70%, 75%, 80%, 85%, 90% or 95% by weight. Consequently, the concentration of structured protein products in the restructured meat product may be about 5%, 10%, 15%, 20%, 25%, 30%, 35%, 40%, 45%, 50%, 55%, 60%, 65%, 70%, 75%, 80%, 85%, 90%, 95%, or 99% by weight.

### DEFINITIONS

The term “extrudate” as used herein refers to the material(s) that are in the extruder screw(s), die assembly, or just exiting the die or extruder. In this context, the structured protein products comprising protein fibers that are substantially aligned may be extrudates in some embodiments.

The term “fiber” or “protein fiber” as used herein refers to a strand or group of strands of protein similar in structure to muscle fibers. In this context, the term “fiber” does not include the nutrient class of dietary fiber, such as soybean cotyledon fiber.

The term “wheat gluten” as used herein refers to “the principal protein component of wheat and consists mainly of gliadin and glutenin. Wheat gluten is obtained by hydrating wheat flour and mechanically working the sticky mass to separate the wheat gluten from the starch and other flour components. Vital gluten is dried gluten that has retained its elastic properties.” (21 CFR 184.1322). In a more general sense, “gluten” may also include proteins from grasses closely related to wheat that have storage proteins that may initiate an allergic response in those allergic to wheat gluten.

The term “gluten free starch” as used herein refers to various starch products. Gluten free or substantially gluten free starches may be made from a variety of starch-containing crops or plants. They are gluten free because they do not contain gluten from wheat, or plants closely related to wheat that have storage proteins that may initiate an allergic response in those allergic to wheat gluten.

The term “long fibers” as used herein refers to protein fibers having greater than 40 millimeter (mm) length, less than 5 mm width, and less than 2 mm thickness.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety.

The term “protein content,” as for example, soy protein content as used herein, refers to the relative protein content of a material as ascertained by A.O.C.S. (American Oil Chemists Society) Official Methods Bc 4-91 (1997), Aa 5-91 (1997), or Ba 4d-90 (1997), each incorporated herein by reference in their entirety, which determine the total nitrogen content of a material sample as ammonia, and the protein content as 6.25 times the total nitrogen content of the sample.

The term “shear strength” as used herein measures resistance of the extruded product to shear perpendicular to the fiber direction. Shear strength is measured in grams. The determination of shear is detailed in Example 12.

The term “soy cotyledon fiber” as used herein refers to the polysaccharide portion of soy cotyledons containing at least about 70% dietary fiber. Soy cotyledon fiber typically contains some minor amounts of soy protein, but may also be 100% dietary fiber. Soy cotyledon fiber, as used herein, does not refer to, or include, soy hull fiber. Generally, soy cotyledon fiber is obtained from soybeans by removing the hull and germ of the soybean, flaking or grinding the cotyledon and removing oil from the flaked or ground cotyledon, and separating the soy cotyledon fiber from the soy material and carbohydrates of the cotyledon.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is typically formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted soybean material, preferably containing less than about 1% hexane-extractable lipids, formed of particles having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis.

The term “soy protein isolate” or “isolated soy protein” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “starch” as used herein refers to starches derived from any native source. Typically sources for starch are cereals, tubers, roots, and fruits. Starches typically contain amylose and amylopectin.

The term “weight on a moisture free basis” as used herein refers to the weight of a material after it has been dried to completely remove all moisture, e.g. the moisture content of the material is 0%. Specifically, the weight on a moisture free basis of a material can be obtained by weighing the material before and after the material has been placed in a 130° C. (or other temperature know to one of ordinary skill in the art) oven until the material reaches a constant weight.

The term “binding agent” as used herein refers to the portion of the extrudate that allows for the formation of protein fibers from the protein in the composition. A binding agent includes, for example, starch.

The term “polysaccharide” as used herein refers to polymers of sugars.

The term “animal protein” as used herein refers to a protein derived from an animal, including, but not limited to, meat, milk, eggs, gelatin, skin, and combinations thereof.

The term “additional constituents” as used herein refers to any component that is neither the binding agent nor the protein that forms the fibers.

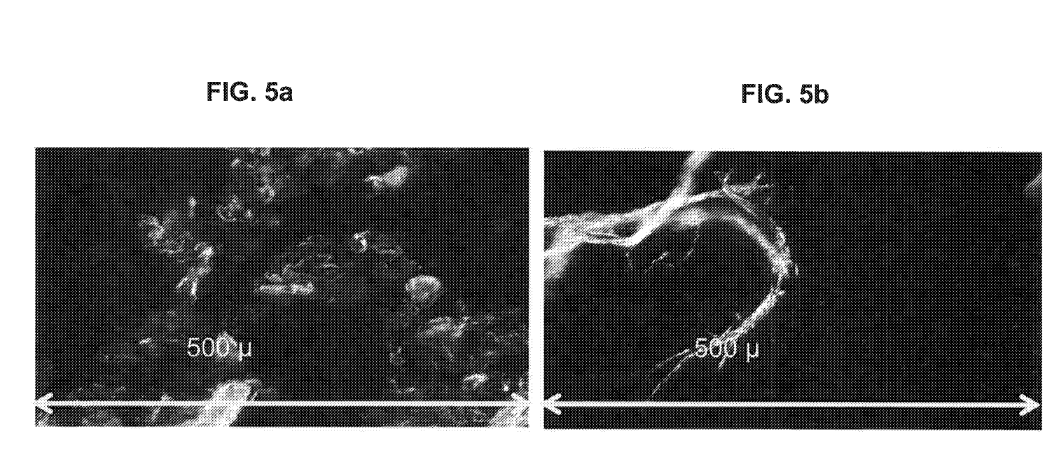

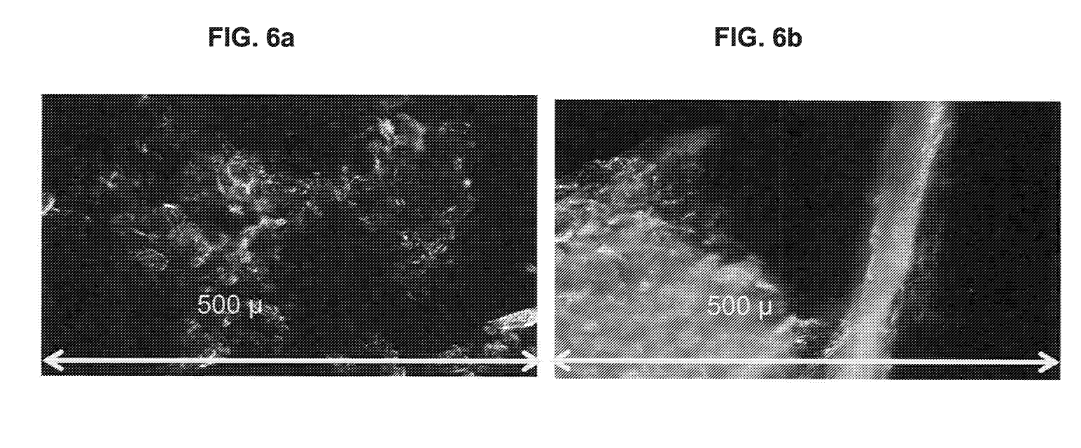

The term “texturized”, “texturizable”, or variant thereof as used herein refers to a protein that is processed to have a meat-like texture from ingredients that do not have a meat-like texture. Many proteins can be processed to produce a texturized protein product (including, for example, soy protein). FIGS. 5a and 6a illustrate a texturized protein product. A texturized protein product is distinguished from a structured protein product of the invention in that the latter forms a protein product having substantially aligned fibers and a muscle-like texture (see, for example, FIGS. 5a and 6a compared to FIGS. 5b and 6b).

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### EXAMPLES

### Example 1

The following example relates to a method for forming a protein composition consisting of at least protein and a binder.

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A stream-lined die with two 13 mm diameter die openings was used. Land length of the die was about 10 mm, or about 0.77 (dimensionless expression).

A blend of 78.8% SUPRO® EX 45 (soy protein isolate), 12.3% Tapioca Starch, 8% Fibrim® 2000 (soy fiber), 0.5% DiCalcium Phosphate, 0.3% Lecithin, 0.1% L-Cysteine was used.

The operating conditions were as follows:

“Dry” Blend Feed Rate: 75 kg/hr

Preconditioner water: 25% of the dry blend feed rate

Preconditioner steam feed rate: 8% of the dry blend feed rate

Barrel water: 8% of the dry blend feed rate

Barrel steam feed rate: 0% of the dry blend feed rate

Extruder Screw Speed: 425 RPM

Extruder Motor Load: 24%

Extruder Specific Mechanical Energy: 80 kW*hr/ton of “dry” feed

Barrel Zone 1 temperature setpoint: 50° C.

Barrel Zone 1 temperature recorded: 49° C.

Barrel Zone 2 temperature setpoint: 70° C.

Barrel Zone 2 temperature recorded: 70° C.

Barrel Zone 3 temperature setpoint: 125° C.

Barrel Zone 3 temperature recorded: 125° C.

Barrel Zone 4 temperature setpoint: 110° C.

Barrel Zone 4 temperature recorded: 109° C.

Shred results (as described in Example 13) were about 32%. Average Shear values (as described in Example 12) were about 2250 grams.

### Example 2

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with six 9 mm die openings was used. Land length of the die was about 6.9 mm, or about 0.77 (dimensionless expression).

A blend of 78.8% SUPRO® EX 45 (soy protein isolate), 12.3% Tapioca Starch, 8% Fibrim® 2000 (soy fiber), 0.5% DiCalcium Phosphate, 0.3% Lecithin, 0.1% L-Cysteine was used.

The operating conditions were as follows:

“Dry” Blend Feed Rate: 80 kg/hr

Preconditioner water: 30% of the dry blend feed rate

Preconditioner steam feed rate: 5% of the dry blend feed rate

Barrel water: 6.5% of the dry blend feed rate

Barrel steam feed rate: 0% of the dry blend feed rate

Extruder Screw Speed: 400 RPM

Extruder Motor Load: 29%

Extruder Specific Mechanical Energy: 82 kW*hr/ton of “dry” feed

Barrel Zone 1 temperature setpoint: 50° C.

Barrel Zone 1 temperature recorded: 51° C.

Barrel Zone 2 temperature setpoint: 70° C.

Barrel Zone 2 temperature recorded: 70° C.

Barrel Zone 3 temperature setpoint: 125° C.

Barrel Zone 3 temperature recorded: 123° C.

Barrel Zone 4 temperature setpoint: 110° C.

Barrel Zone 4 temperature recorded: 110° C.

Shred results (as described in Example 13) were about 24%. Average Shear values (as described in Example 12) were about 2950 grams.

### Example 3

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with six 10 mm die openings was used. Land length of the die was about 7.7 mm, or about 0.77 (dimensionless expression).

A blend of: 78.8% SUPRO® 595 (soy protein isolate), 12.3% Tapioca Starch, 8.0% Fibrim® 2000 (soy fiber), 0.5% DiCalcium Phosphate, 0.3% Lecithin, 0.1% L-Cysteine was used.

The operating conditions were as follows:

“Dry” Blend Feed Rate: 65 kg/hr

Preconditioner water: 23% of the dry blend feed rate

Preconditioner steam feed rate: 8% of the dry blend feed rate

Barrel water: 29% of the dry blend feed rate

Barrel steam feed rate: 0% of the dry blend feed rate

Extruder Screw Speed: 425 RPM

Extruder Motor Load: 21%

Extruder Specific Mechanical Energy: 79 kW*hr/ton of “dry” feed

Barrel Zone 1 temperature setpoint: 50° C.

Barrel Zone 1 temperature recorded: 62° C.

Barrel Zone 2 temperature setpoint: 70° C.

Barrel Zone 2 temperature recorded: 71° C.

Barrel Zone 3 temperature setpoint: 130° C.

Barrel Zone 3 temperature recorded: 126° C.

Barrel Zone 4 temperature setpoint: 140° C.

Barrel Zone 4 temperature recorded: 143° C.

Shred results (as described in Example 13) were about 44%. Average Shear values (as described in Example 12) were about 3450 grams.

### Example 4

A structured soy protein product was formed according to the following process.

The extruder used was a Wenger TX-52 MAC ST, 19.5:1 Length:Diameter (L:D), equipped with a 50 hp drive motor, equipped with a Model 4 DDC Conditioning Cylinder.

A die with six 10 mm die openings was used. Land length of the die was about 7.7 mm, or about 0.77 (dimensionless expression).

A blend of: 78.8% SUPRO® EX 45 (soy protein isolate), 12.3% Tapioca Starch, 8% Fibrim® 2000 (soy fiber), 0.5% DiCalcium Phosphate, 0.3% Lecithin, 0.1% L-Cysteine was used.

The operating conditions were as follows:

“Dry” Blend Feed Rate: 75 kg/hr

Preconditioner water: 27% of the dry blend feed rate

Preconditioner steam feed rate: 8% of the dry blend feed rate

Barrel water: 20% of the dry blend feed rate

Barrel steam feed rate: 0% of the dry blend feed rate

Extruder Screw Speed: 425 RPM

Extruder Motor Load: 25%

Extruder Specific Mechanical Energy: 82 kW*hr/ton of “dry” feed

Barrel Zone 1 temperature setpoint: 50° C.

Barrel Zone 1 temperature recorded: 56° C.

Barrel Zone 2 temperature setpoint: 70° C.

Barrel Zone 2 temperature recorded: 73° C.

Barrel Zone 3 temperature setpoint: 130° C.

Barrel Zone 3 temperature recorded: 128° C.

Barrel Zone 4 temperature setpoint: 140° C.

Barrel Zone 4 temperature recorded: 145° C.

Shred results (as described in Example 13) were about 62%. Average Shear values (as described in Example 12) were about 2750 grams.

### Example 5

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 79.4% SUPRO® 620 (soy protein isolate), 12.4% Tapioca Starch, 8.1% Fibrim® 2000 (soy fiber), 0.1% L-Cysteine was used.

The operating conditions were as follows:

“Dry” Blend Feed Rate: 60 kg/hr

Preconditioner water: 25% of the dry blend feed rate

Preconditioner steam feed rate: 7.5% of the dry blend feed rate

Barrel water: 10% of the dry blend feed rate

Barrel steam feed rate: 0% of the dry blend feed rate

Extruder Screw Speed: 360 RPM

Extruder Motor Load: 20%

Extruder Specific Mechanical Energy: 68 kW*hr/ton of “dry” feed

Barrel Zone 1 temperature setpoint: 50° C.

Barrel Zone 1 temperature recorded: 49° C.

Barrel Zone 2 temperature setpoint: 70° C.

Barrel Zone 2 temperature recorded: 73° C.

Barrel Zone 3 temperature setpoint: 120° C.

Barrel Zone 3 temperature recorded: 119° C.

Barrel Zone 4 temperature setpoint: 135° C.

Barrel Zone 4 temperature recorded: 133° C.

Shred results (as described in Example 13) were about 52%. Average Shear values (as described in Example 12) were about 3050 grams.

### Example 6

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 78.8% SUPRO® 620 (soy protein isolate), 12.3% Corn Flour, 8.0% Fibrim® 2000 (soy fiber), 0.5% DiCalcium Phosphate, 0.3% Lecithin, 0.13% L-Cysteine was used.

The operating conditions were as follows:

“Dry” Blend Feed Rate: 75 kg/hr

Preconditioner water: 25% of the dry blend feed rate

Preconditioner steam feed rate: 7.5% of the dry blend feed rate

Barrel water: 15% of the dry blend feed rate

Barrel steam feed rate: 0% of the dry blend feed rate

Extruder Screw Speed: 400 RPM

Extruder Motor Load: 24%

Extruder Specific Mechanical Energy: 71 kW*hr/ton of “dry” feed

Barrel Zone 1 temperature setpoint: 50° C.

Barrel Zone 1 temperature recorded: 49° C.

Barrel Zone 2 temperature setpoint: 70° C.

Barrel Zone 2 temperature recorded: 79° C.

Barrel Zone 3 temperature setpoint: 125° C.

Barrel Zone 3 temperature recorded: 125° C.

Barrel Zone 4 temperature setpoint: 135° C.

Barrel Zone 4 temperature recorded: 136° C.

Shred results (as described in Example 13) were about 58%. Average Shear values (as described in Example 12) were about 4200 grams.

### Example 7

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 88% SUPRO® 620 (soy protein isolate), 12% Tapioca Starch was used.

The operating conditions were as follows:

“Dry” Blend Feed Rate: 65 kg/hr

Preconditioner water: 27% of the dry blend feed rate

Preconditioner steam feed rate: 7.5% of the dry blend feed rate

Barrel water: 11% of the dry blend feed rate

Barrel steam feed rate: 0% of the dry blend feed rate

Extruder Screw Speed: 360 RPM

Extruder Motor Load: 20%

Extruder Specific Mechanical Energy: 66 kW*hr/ton of “dry” feed

Barrel Zone 1 temperature setpoint: 50° C.

Barrel Zone 1 temperature recorded: 48° C.

Barrel Zone 2 temperature setpoint: 70° C.

Barrel Zone 2 temperature recorded: 70° C.

Barrel Zone 3 temperature setpoint: 120° C.

Barrel Zone 3 temperature recorded: 124° C.

Barrel Zone 4 temperature setpoint: 135° C.

Barrel Zone 4 temperature recorded: 135° C.

Shred results (as described in Example 13) were about 37%. Average Shear values (as described in Example 12) were about 2450 grams.

### Example 8

A structured soy protein product was formed according to the following process.

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 84.1% PROCON® 2000 (soy protein concentrate), 15% Tapioca Starch, 0.5% DiCalcium Phosphate, 0.3% Lecithin, 0.1% L-Cysteine were combined.

The operating conditions were as follows:

“Dry” Blend Feed Rate: 60 kg/hr

Preconditioner water: 27% of the dry blend feed rate

Preconditioner steam feed rate: 8% of the dry blend feed rate

Barrel water: 20% of the dry blend feed rate

Barrel steam feed rate: 0% of the dry blend feed rate

Extruder Screw Speed: 350 RPM

Extruder Motor Load: 23%

Extruder Specific Mechanical Energy: 78 kW*hr/ton of “dry” feed

Barrel Zone 1 temperature setpoint: 50° C.

Barrel Zone 1 temperature recorded: 50° C.

Barrel Zone 2 temperature setpoint: 70° C.

Barrel Zone 2 temperature recorded: 71° C.

Barrel Zone 3 temperature setpoint: 125° C.

Barrel Zone 3 temperature recorded: 125° C.

Barrel Zone 4 temperature setpoint: 135° C.

Barrel Zone 4 temperature recorded: 132° C.

Shred results (as described in Example 13) were about 47%. Average Shear values (as described in Example 12) were about 2300 grams,

### Example 9

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 88% PROCON® 2000 (soy protein concentrate), and 12% Tapioca Starch were combined.

The operating conditions were as follows:

“Dry” Blend Feed Rate: 60 kg/hr

Preconditioner water: 27% of the dry blend feed rate

Preconditioner steam feed rate: 8% of the dry blend feed rate

Barrel water: 17% of the dry blend feed rate

Barrel steam feed rate: 0% of the dry blend feed rate

Extruder Screw Speed: 350 RPM

Extruder Motor Load: 24%

Extruder Specific Mechanical Energy: 79 kW*hr/ton of “dry” feed

Barrel Zone 1 temperature setpoint: 50° C.

Barrel Zone 1 temperature recorded: 51° C.

Barrel Zone 2 temperature setpoint: 70° C.

Barrel Zone 2 temperature recorded: 66° C.

Barrel Zone 3 temperature setpoint: 120° C.

Barrel Zone 3 temperature recorded: 119° C.

Barrel Zone 4 temperature setpoint: 135° C.

Barrel Zone 4 temperature recorded: 137° C.

Shred results (as described in Example 13) were about 34%. Average Shear values (as described in Example 12) were about 2650 grams.

### Example 10

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 100% Soy Flour was utilized.

The operating conditions were as follows:

“Dry” Blend Feed Rate: 75 kg/hr

Preconditioner water: 25% of the dry blend feed rate

Preconditioner steam feed rate: 7% of the dry blend feed rate

Barrel water: 7% of the dry blend feed rate

Barrel steam feed rate: 0% of the dry blend feed rate

Extruder Screw Speed: 400 RPM

Extruder Motor Load: 27%

Extruder Specific Mechanical Energy: 82 kW*hr/ton of “dry” feed

Barrel Zone 1 temperature setpoint: 50° C.

Barrel Zone 1 temperature recorded: 50° C.

Barrel Zone 2 temperature setpoint: 70° C.

Barrel Zone 2 temperature recorded: 68° C.

Barrel Zone 3 temperature setpoint: 125° C.

Barrel Zone 3 temperature recorded: 125° C.

Barrel Zone 4 temperature setpoint: 135° C.

Barrel Zone 4 temperature recorded: 135° C.

Shred results (as described in Example 13) were about 29%. Average Shear values (as described in Example 12) were about 3800 grams.

### Example 11

A structured soy protein product was formed according to the following process:

The extruder used was a Wenger TX-52 MAG ST, 19.5:1 Length:Diameter (L:D), equipped with a 50 hp drive motor, equipped with a Model 4 DDC Conditioning Cylinder.

A die with two 13 mm diameter die openings was used. Land length of the die was about 10 mm, or about 0.77 (dimensionless expression).

A blend of: 48.6% SUPRO® 620 (soy protein isolate), 40% PROCON® 2000 (Soy Protein Concentrate) 10.5% Tapioca Starch, 0.5% DiCalcium Phosphate, 0.3% Lecithin, 0.1% L-Cysteine was used.

The operating conditions were as follows:

“Dry” Blend Feed Rate: 75 kg/hr

Preconditioner water: 25% of the dry blend feed rate

Preconditioner steam feed rate: 7.5% of the dry blend feed rate

Barrel water: 18% of the dry blend feed rate

Barrel steam feed rate: 0° A of the dry blend feed rate

Extruder Screw Speed: 400 RPM

Extruder Motor Load: 25%

Extruder Specific Mechanical Energy: 78 kW*hr/ton of “dry” feed

Barrel Zone 1 temperature setpoint: 50° C.

Barrel Zone 1 temperature recorded: 50° C.

Barrel Zone 2 temperature setpoint: 70° C.

Barrel Zone 2 temperature recorded: 68° C.

Barrel Zone 3 temperature setpoint: 125° C.

Barrel Zone 3 temperature recorded: 125° C.

Barrel Zone 4 temperature setpoint: 140° C.

Barrel Zone 4 temperature recorded: 140° C.

Shred results (as described in Example 13) were about 34%. Average Shear values (as described in Example 12) were about 3350 grams.

### Example 12

The following tests were used to analyze the shear of the product produced in Examples 1-11.

The procedure and target results were for a chunk with dry (about 10% moisture as-is) dimensions of approximately 6 cm in length by 2.5 cm in diameter, with the probe cutting through a cross-section of the chunk. The equipment used was as follows:
I. Texture Analyzer: Stable Micro Systems: TA XTPlus or TA XT2i Equipped with:
   A. 25, 50 or 100 Kg load cell
   B. TA-45 Incisor knife
   C. Sample platform;
      1) TA XTPlus—TA-90 Heavy Duty Platform;
      2) TA XT2i instruments typically used the base plate from the TA-7 Warner Bratzler Knife Blade.
II. Vacuum packaging: Vacuum pouch providing an air barrier of sufficient size to contain the sample pieces in a single layer. Examples include:
   A. Model KVP-420T vacuum sealer with an effective heat sealing size of 2×400 mm, manufactured by Kingstar Manufacturing Co. (China) and distributed by Food Processing Equipment, Inc.; or equivalent
   B. Selovac 200 B XL; or equivalent.
III. Scissors.
IV. Balance—5000 g capacity, sensitivity±5 g minimum.
V. The equipment was prepared as follows:
   A. Vacuum packager: 1) verify that the packager is able to reduce pressure to 0.05 bar (<37.5 mm Hg). 2) The settings for making consistent seals vary by packager and pouch used. Adjust sealing pulse to insure complete sealing of the vacuum pouch used for analysis.
   B. Texture analyzer: 1) Calibrate the Texture-Analyzer force once daily, per manufacturer's recommendations. 2) The following settings should be entered and the texture analyzer should be updated:
(a) Measure Force in Compression
(b) Return to Start
(c) Parameters:
(d) Pretest Speed 10 mm/sec
(e) Test Speed 2.0 mm/sec
(f) Post-test Speed 10 mm/sec
(g) Rupture Test Distance (N/A)
(h) Distance (strain) 160%
(i) Force (N/A)
(j) Time (N/A)
(k) Load Cell (use local value)
(l) Temp (N/A)
(m) Trigger:
(n) Trigger type Auto
(o) Force 20 g
(p) Stop plot at Final
(q) Auto Tare yes
(r) Units:
(s) Force grams
(t) Distance % strain
(u) Break:
(v) Detect off
(w) Level (N/A)
(x) Sensitivity (N/A)
   C. Data processing: 1) Enter a macro having the following sequence of commands. Note: Different versions of the software may have different commands, use the appropriate commands.
      (a) Clear Graph Results
      (b) Go to Min. Time
      (c) Redraw
      (d) Set Force Threshold 1000 g
      (e) Search Forward
      (f) Go to Force
      (g) Percent of Max Force 100%
      (h) prop Anchor
      (i) Mark Value (Force)
VI. Tap water 25° C. +/−2° C. is used as a reagent.
VII. The procedure practiced was as follows:
   1) Hydrate the product.
      (a) 15 whole pieces of dry product are weighed, the sample weight recorded, and the pieces placed into vacuum pouch labeled with the sample ID.
      (b) The water for hydration is a ratio of 3 parts water to one part sample by weight. (Sample weight×3). For example: If the 15 pieces of product weigh 150 grams, add 3×150 grams=450 grams of water to the bag.
      (c) The water is added to the bag carefully, avoiding wetting the walls of the pouch to insure a good heat seal.
      (d) The pouch is placed into the vacuum sealer and the sample chunks are distributed in an even layer within the bag. No pieces are “stacked” on top of one another. The bag is supported inside the vacuum sealer in a slightly inclined position to prevent water leakage.
      (e) The start time is labeled.
      (f) The barrier pouch is vacuumed to 0.05 Bar (<37.5 mm Hg) and the barrier pouch is sealed. NOTE: 0.05 bar represents reducing the pressure to <5% or the current atmospheric pressure. Gauges provided by different vendors may read in cm Hg. Therefore the absolute cm Hg vacuum reading can vary based on the atmospheric pressure of the location on any given day.
      (g) The pouch is examined for leaks. If leaks are found, a new sample is prepared (start at (a) above).
      (h) The product is allowed to hydrate and equilibrate for 12 to 24 hours prior to texture analysis.
   2) The texture analyzer probe is zeroed.
   3) The knife fixture is attached to the texture analyzer.
   4) The slotted plate is placed into the platform and the plate is tightened.
   5) The knife is aligned with the slot in the plate so that the knife will pass through the center of the slot.
   6) The knife fixture is tightened.
   7) The standard texture analyzer procedure is followed to zero the probe, and raise the blade of the probe to a height of about 40 mm above the plate.
   8) The bag is cut open with scissors to remove one of the pieces of product.
   9) The piece is placed lengthwise, perpendicular to the direction of the slot in the plate, so that the knife will cut through the center of the piece rather than one of the ends.
   10) The piece is centered so that the measurement is made in the center away from the ends.
   11) The texture-analyzer is started.
   12) The maximum force needed to cut (shear) the piece is collected and recorded.
   13) The test is repeated for at least 10 replicates (total). The calculations (results) are done as follows: Record the average maximum force (grams) and the standard deviation of the measurements.

### Example 13

The following test was used to analyze the product in Examples 1-11.

The procedure and target results are for a chunk dried to about 10% moisture and with dry dimensions of approximately 6 cm in length by 2.5 cm in diameter. If a different shape or size of chunk is used, it will need to be corrected to this size and shape.

I. The shred test is as follows:
A. Benchtop Mixer (Kitchen Aid mixer model KM14G0 or equivalent with bowl and single-blade paddle)
B. Balance 5000 g capacity with precision±5 g minimum.
C. Vacuum packaging: as described in Example 12.
   II. The equipment is prepared as follows:
A. Vacuum packager: as described in Example 12
B. Benchtop Mixer: set to provide 130±2 rpm. RPM is judged by observing the primary shaft on the cam, not the rotation of the paddle.
C. Tap water at 25±2° C.
   III. The procedure to follow is:
A. Hydration: As described in Example 12.
B. Shred and evaluate the product.
   1) Remove the hydrated chunk from the vacuum pouch and place the hydrated chunk in the mixer bowl. Set the mixer to the proper speed (130 rpm) and turn it on.
   2) Mix for 2 minutes, stop the mixer, unplug it, carefully place material wrapped on the paddle into the bowl, and scrape the bowl to bring any material down from the walls of the bowl to the main mass of material.
   3) Mix for 2 additional minutes, stop the mixer, unplug it, carefully place material wrapped on the paddle into the bowl, and scrape the bowl to bring any material down from the walls of the bowl to the main mass of material.
   4) Mix for 2 more minutes, stop the mixer, unplug it, carefully place material wrapped on the paddle into the bowl, and scrape the bowl to bring any material down from the walls of the bowl to the main mass of material.
   5) Hand mix the product in the bowl once more to redistribute sample adhering to the mixer paddle or sides of the bowl.
   6) Weigh 50±0.5 grams of the shredded product from the bowl. The 50 grams needs to be representative of the total material shredded.
   7) Separate the product into the following 4 groups using the convention: “long”=longest dimension; “wide”=middle dimension; “high”=shortest dimension.
      (a) Long fibers: Length>40 mm, maximum 5 mm width, maximum 2 mm thickness. Record the total weight of all long fibers.
      (b) Short fibers: 25 mm=length=40 mm, maximum 5 mm width, maximum 2 mm thickness. Record the total weight of all short fibers.
      (c) Sheets (similar to a sheet of paper): Length>25 mm, minimum 5 mm width, maximum 2 mm thickness. Record the total weight of all sheets.
   8) The shred score is recorded as 100% X (weight of long fibers+weight of short fibers+weight of sheets)/total sample weight. All groups need to at similar moisture contents to give a valid measurement.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A structured protein product with substantially aligned fibers, the product comprising at least one gluten-free protein material and a binding agent.

2. The product of claim 1 wherein the protein material is a soy protein or other texturizable protein.

3. The product of claim 2 wherein the soy protein is selected from the group consisting of soy isolate, soy protein concentrate, soy flour, and combinations thereof.

4. The product of claim 1 wherein the at least one gluten-free protein material and a binding agent is a single source ingredient.

5. The product of claim 1 wherein the binding agent is selected from the group consisting of polysaccharides, mono-saccharides, di-saccharides, and combinations thereof.

6. The product of claim 5 wherein the binding agent is selected from the group consisting of starch, starch-substitutes, and combinations thereof.

7. The product of claim 1 wherein the protein material is present in an amount ranging between 75% and 100% and the binding agent is present in an amount ranging between 0% and 25%.

8. The product of claim 1 wherein the binding agent is selected from the group consisting of proteins, lipids, and combinations thereof.

9. The product of claim 1 wherein the structured protein product has an average shear strength of at least 1400 grams and an average shred characterization of at least 17%.

10. The product of claim 1 wherein the structured protein product has an average shear strength of at least 2000 grams and an average shred characterization of at least 17%.

11. The product of claim 1 wherein the structured protein product has an average shear strength of at least 2600 grams and an average shred characterization of at least 17%.

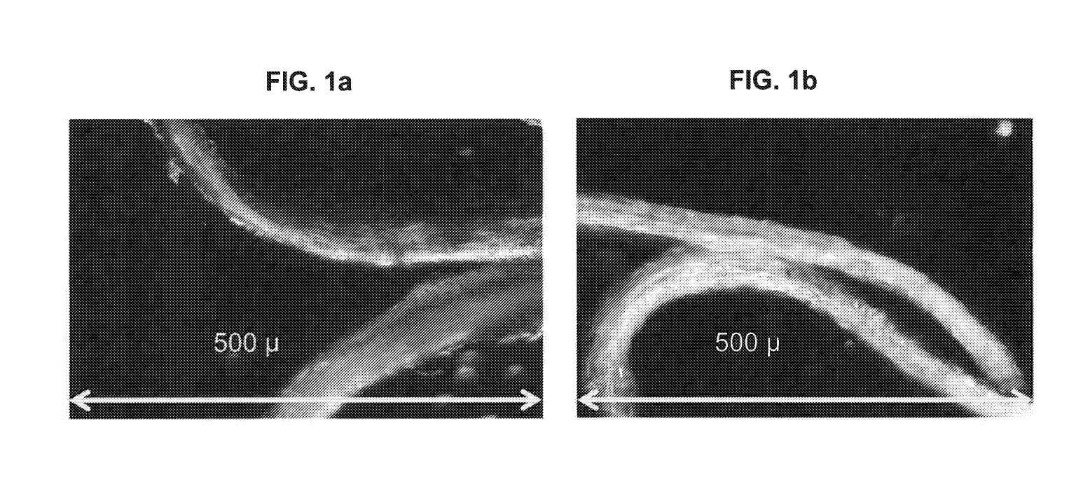

12. The product of claim 1 wherein the structured protein product comprises protein fibers substantially aligned in the manner depicted in the micrographic image of FIG. 1b.

13. The product of claim 1 further comprising a coloring composition.

14. The product of claim 13 wherein the coloring composition comprises beet, annatto, caramel coloring, and an amino acid source.

15. The product of claim 1 further comprising an antioxidant, water, spices, and flavoring.

16. A restructured product comprising the protein product of claim 1.

17. The restructured product of claim 16 wherein the restructured product comprises meat.

18. The restructured product of claim 16 wherein the restructured product is meat-free.

19. A process for producing a structured protein product, the process comprising: extruding at least one gluten-free protein material and a binding agent through a die assembly to form a structured protein product having protein fibers that are substantially aligned.

20. The process of claim 19 wherein the structured protein product has an average shear strength of at least 1400 grams and an average shred characterization of at least 17%.

21. The process of claim 19 wherein the structured protein product has an average shear strength of at least 2000 grams and an average shred characterization of at least 17%.

22. The process of claim 19 wherein the structured protein product has an average shear strength of at least 2600 grams and an average shred characterization of at least 17%.

23. The process of claim 19 wherein the structured protein product comprises protein fibers substantially aligned in the manner depicted in the micrographic image of FIG. 1b.

24. The process of claim 19 wherein the protein material has from about 40% to about 90% protein on a dry matter basis.
